(19) United States
(12) Patent Application Publication
(10) Pub. No.: US 2010/0212985 A1
(43) Pub. Date: Aug. 26, 2010

(54) TRANSMISSION SYSTEM FOR A CYCLE

(76) Inventor: Gregory N. Clausen, Tasmania (AU)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/680,769

(22) PCT Filed: Feb. 17, 2008
(86) PCT No.: PCT/AU08/00196

§ 371 Date: Mar. 30, 2010

(30) Foreign Application Priority Data
Jun. 27, 2007 (AU) 2007903452
Nov. 16, 2007 (AU) 2007906267

(51) Int. Cl. B62M 23/02; B62M 1/00

(52) U.S. Cl. 180/205; 280/210

(57) ABSTRACT

A transmission system for a cycle having a drive means and at least one driven wheel. The transmission system includes a driven member operatively connected to the drive means, the driven member being selectively driven by the drive means; at least one fixture fixedly connected to the at least one driven wheel; and at least one coupling member which is releasably receivable in or on each of the driven member and the fixture to releasably connect the driven member to the fixture. The transmission system is configured so that one or more coupling members can be selectively used to releasably connect the driven member to the fixture and thereby allow the drive means to drive rotation of the at least one driven wheel.

### FIELD OF THE INVENTION

The present invention generally relates to a transmission system for a cycle. The invention is particularly applicable for use in transmitting power from an auxiliary drive means to at least one wheel of a pedal powered bicycle and it will be convenient to hereinafter disclose the invention in relation to that exemplary application. However, it is to be appreciated that the invention is not limited to that application and could be used in any type of cycle arrangement where it is desirable to use one or both of a motorised drive means and pedal power to drive the rotation of a wheel.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Cycling is a popular form of transportation. Most cycles are powered using two foot actuated crank arms (including pedals) which drive the rotation of a driven wheel of the cycle through two chain connected sprockets, one sprocket being connected to the crank arms, the other sprocket being connected to the driven wheel. While this drive means is very energy efficient, it can be tiring for an individual to use pedal power to negotiate hills or other inclines. It can therefore be desirable to include an auxiliary power unit, such as a motor, on a cycle to provide a rider with additional power to assist with pedaling.

Many auxiliary power unit arrangements are available for powering a bicycle. One common arrangement includes a drive unit, typically a gasoline motor attached to the bicycle frame, a driven sprocket fixed to the rear wheel of the bicycle and a chain operatively connecting the drive unit and the driven sprocket.

This type of auxiliary power unit arrangement is mostly used as a retrofitted assembly designed to permanently convert the bicycle to a power assisted bicycle. In this respect, the driven sprocket is permanently fixed to a wheel of the bicycle. Therefore, in order to power the bicycle by pedal power, the rider must also actuate the connected transmission system of the auxiliary power unit. As can be appreciated, the additional resistance created by the connected transmission system can make this pedal power motion less energy efficient.

It would therefore be desirable to provide a transmission system for a drive means that can be selectively engaged and disengaged from a wheel of a cycle. Accordingly, a rider could disengage the transmission system and move the bicycle by pedal power without additional resistance created by the arrangement of the transmission and drive means.

### SUMMARY OF THE INVENTION

According to the present invention, there is provided a transmission system for a cycle having a drive means and at least one driven wheel, the transmission system comprising:

a driven member operatively connected to the drive means, the driven member being selectively driven by the drive means;

at least one fixture fixedly connected to the at least one driven wheel; and

at least one coupling member which is releasably receivable in or on each of the driven member and the fixture to releasably connect the driven member to the fixture and thereby allow the drive means to drive rotation of the at least one driven wheel.

Accordingly, a transmission system according to the present invention allows a rider to selectively engage and disengage an auxiliary drive means from driving rotation of a driven wheel of a cycle. The present invention therefore allows a rider to retain the favourable characteristics of a pedal powered cycle, such as use of a standard derailleur, gearing system and independent pedal power, while also having the convenience of being able to selectively enable an auxiliary drive source to assist the rider drive rotation of the driven wheel. Moreover, by sensibly operating a transmission system according to the invention, a rider can minimise use of the drive unit and thereby conserve fuel, conserve engine life and minimise greenhouse gas emissions.

It should be appreciated that a transmission system according to the present invention can be included in any desired form of cycle such as a bicycle, tricycle, quadricycle, unicycle or the like. In those embodiments where the cycle is a bicycle, both the transmission system and the pedal drive arrangement are preferably operatively connected to a rear wheel of the bicycle.

It is to be understood that the driven wheel of a cycle is that wheel that is actuated to drive motion of the cycle. It should be appreciated that a cycle can have one or more driven wheels, as rotation of one or more wheels of that cycle could be actuated by one or more transmission systems connected to one or more different drive means. Where the cycle is a bicycle having a front wheel and a rear wheel, the driven wheel operatively associated with the drive means preferably comprises the rear wheel of the bicycle.

Most cycles, including bicycles, include a pedal drive arrangement for manually driving the rotation of a rear driven wheel of the cycle. The pedal drive arrangement usually includes foot actuated crank arms having pedals which drive the rotation of a pedal sprocket. The pedal sprocket is connected by a chain to a sprocket which is fixedly connected to the rear wheel of the cycle. Of course, most modern cycles also include a gearing system comprising either an internally geared hub or having a series of sprockets and one or more derailleur devices used to move the chain between the sprockets. In such cycle arrangements it can be desirable to drive the driven wheel using pedal power or drive the driven wheel using a combination of pedal power and power from the drive means. Accordingly, the transmission system is preferably configured to allow the pedal drive arrangement to drive rotation of the driven wheel when the at least one coupling member is removed to disconnect the driven member and the fixture.

The driven member can be any component that can be coupled to the drive means and driven by the drive means. In one embodiment, the driven member is a sprocket (the “driven sprocket”). In such an embodiment, the drive means could include a corresponding drive sprocket which is operatively connected to the driven sprocket using a chain such as a roller chain, toothed belt or the like. In another embodiment, the driven member is a pulley wheel. In such an embodiment, the drive means could include a corresponding pulley wheel which is operatively connected to the driven pulley wheel using a belt, cord, chain or the like. In this sense, the driven member can be operatively connected to the drive means using a chain or belt. Preferably, the driven member can be operatively connected to the drive means using a roller chain.

The drive means is preferably a motorised drive means selected from an electric motor, an internal combustion engine, a pneumatic motor or combination thereof.

The fixture can be any suitable member that can be fixedly secured to the driven wheel of the cycle. Most cycle wheels include a hub located at the rotational center of the wheel. The hub typically includes an axle, bearings and a hub shell. In some embodiments, the fixture comprises a component that is fixed to the hub of the driven wheel. Of course, the fixture can have various configurations. In one form, the fixture comprises a series of plates that are affixed to the at least one driven wheel of the cycle. In another form the fixture comprises an annular member. In yet another form, the fixture includes an assembly of interconnected plates. In some embodiments in which the at least one driven wheel includes three or more spokes, the transmission system further includes a mounting member configured which fixedly mounts the fixture to at least two of the three or more spokes by clamping said spokes between the mounting member and said assembly of interconnected plates of the fixture. In those embodiments where the fixture is a component that comprises an assembly of interconnected plates, the assembly of interconnected plates can be preferably affixed to three or more spokes of the driven wheel by clamping said spokes between the said assembly of interconnected plates of the fixture.

The driven member and the fixture are preferably arranged proximate to each other to facilitate easy releasable coupling therebetween. Typically, this necessitates the driven member and the fixture to be aligned in one or more orientations relative to the at least one driven wheel. In one embodiment, the driven member and the fixture are coaxially arranged about an axis of rotation of the at least one driven wheel. Of course, most cycle wheels include an axle at the axis of rotation. Accordingly, it is preferable for the driven member and the fixture to be coaxially arranged about the axle of the at least one driven wheel.

The coupling members can be any suitable fastening device that can be affixed to or through each of the driven member and the fixture to interconnect these members. Suitable fastening devices include buckles, buttons, clips, pins, shafts, bolts, cords, chains, clamps, threads, nails, catches, clasps, latches, locks, rivets, or the like. Each of these fastening devices can cooperate with a complementary recess, groove or corresponding fastening device provided in one or both of the driven member and the fixture. In one preferred embodiment, each of the driven member and the fixture includes one or more cooperating openings configured to releasably receive the at least one coupling member. The cooperating openings of each of the driven member and the fixture can be preferably coaxially aligned to receive the at least one coupling member. In such an embodiment, the at least one coupling member can comprise one or more shafts configured to be received in the one or more cooperating openings of the driven member and the fixture. Preferably, each of the one or more shafts is fitted within the one or more cooperating openings of the driven member.

It can be advantageous to be able to lock the at least one coupling member in position when connecting the drive member and the fixture. Accordingly, in some embodiments each coupling member includes a locking element to lock the coupling member in place. Suitable locking members include cooperating nuts, pins, caps, plates, locks or the like. In those embodiments in which the coupling members comprise shafts, each shaft can include a locking element to lock the one or more shafts within the cooperating openings. One form of the locking element includes a Velcro tape or spring that is placed over a head of the shaft. Another form of the locking element includes nut screwed over a head of a threaded section of the shaft. Yet another form of the locking element comprises a removable pin. In one exemplary embodiment, the coupling members comprise one or more self-locking industrial clevis-type pins such as a self-locking detent pin available from G. L. Huyett in Minneapolis, United States of America. As can be appreciated, such self-locking detent pins include a radially biased locking member, such as a ball bearing, which is recessed within a recess or hole in the shaft of the detent pin. The locking member is configured to move between a position where the locking member is recessed within the shaft of the coupling member and an extended position where it extends radially outwardly from the shaft.

The driven member is preferably configured to move independently to the at least one driven wheel of the cycle when not connected to the driven wheel through the fixture. However, in many embodiments the at least one driven member is connected to the cycle about an axis of rotation of the at least one driven wheel, and more particularly to the axle of the at least one driven wheel. In order to have independent movement, the driven member is preferably mounted on a rotatable member capable of rotating independently to the at least one driven wheel. Of course, this rotational independence can be provided by any number of devices. In one preferred embodiment, the rotatable member comprises a rotary hub axially associated with the axle of the at least one driven wheel. The rotary hub preferably includes a bearing section allowing at least one section to rotate independently relative to the at least one driven wheel.

According to another aspect of the present invention, there is provided a transmission system for a cycle having a drive means and at least one driven wheel, the transmission system comprising:

a driven member operatively connected to the drive means, the driven member being coaxially arranged with an axis of rotation of the at least one driven wheel and being selectively driven by the drive means;

at least one fixture fixedly connected to the at least one driven wheel; and

two or more coupling shafts which are releasably receivable within cooperating openings in the driven member and the fixture to releasably connect the driven member to the fixture and thereby allow the drive means to drive rotation of the at least one driven wheel.

### BRIEF DESCRIPTION OF THE DRAWINGS

The present invention will now be described with reference to the figures of the accompanying drawings, which illustrate particular preferred embodiments of the present invention, wherein:

FIG. 1 is a left hand side view of a bicycle including a drive motor that is fitted with a transmission system in accordance with one preferred embodiment of the present invention.

FIG. 2 is a more detailed view of the transmission system fitted to the bicycle shown in FIG. 1.

FIG. 3 is a rear view of the rear wheel hub showing the components of the driven wheel, including the transmission system shown in FIG. 1.

FIG. 4 is an exploded view of the transmission system shown in FIG. 3.

FIG. 5 is a front elevation view showing a configuration of a spoke fixture assembly for a thirty-six spoked wheel for a transmission system according to the present invention.

FIG. 6 is a front elevation view of the driven sprocket of the transmission system that cooperates with the spoke fixture assembly shown in FIG. 5.

FIG. 7 is a front elevation view showing the configuration of a spoke fixture assembly for a thirty-two spoked wheel for a transmission system according to the present invention.

FIG. 8 is a front elevation view of the driven sprocket of the transmission system that cooperates with the spoke fixture assembly shown in FIG. 7.

FIG. 9 is a front elevation view showing another configuration of spoke fixture assembly for a thirty-six spoked wheel with a wide diameter hub configuration for a transmission system according to the present invention.

FIG. 10 is a front elevation view of the driven sprocket of the transmission system that cooperates with the spoke fixture assembly shown in FIG. 9.

### DETAILED DESCRIPTION

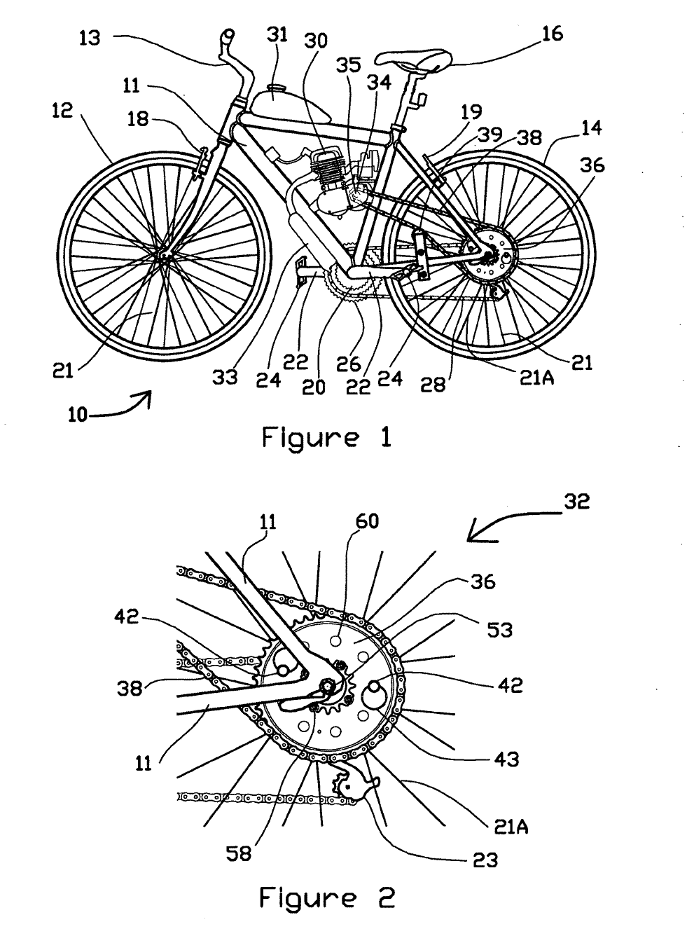

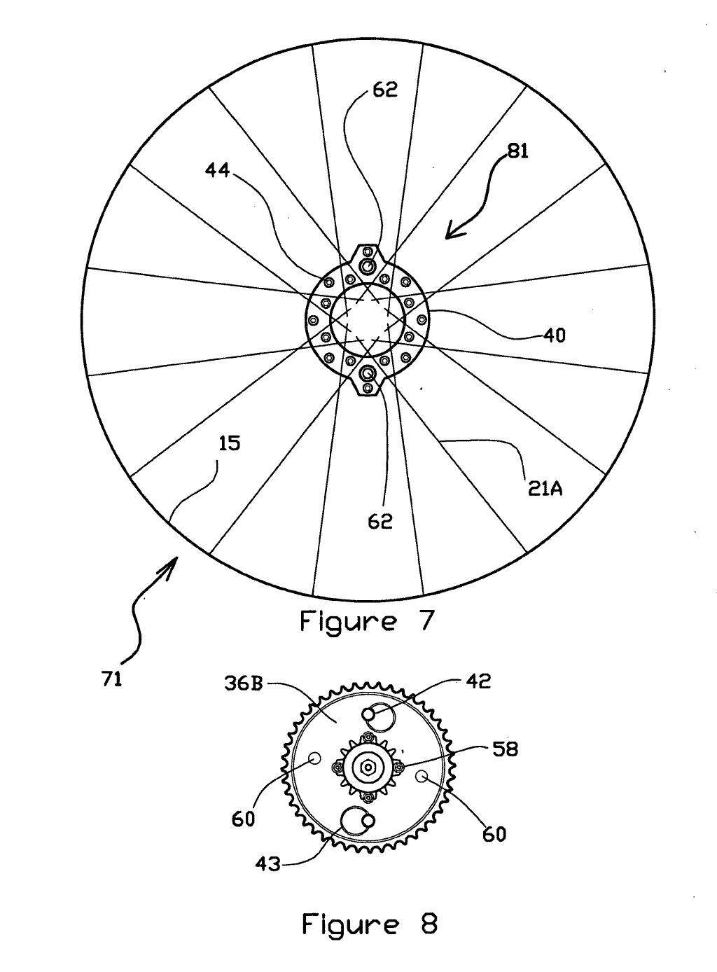

Referring firstly to FIGS. 1 to 6, there is shown a conventional bicycle 10 fitted with a transmission system 32 according to the present invention. Referring firstly to FIG. 1, it can be observed that the bicycle 10 includes a tubular frame 11 to which is connected a front wheel 12 which can be laterally directed using a steering handlebar 13, a driven wheel 14 being the rear wheel of the bicycle 10, front brakes 18, and rear brakes 19 and a seat 16 on which a rider (not shown) can be seated when riding the bicycle 10. Each of the front wheel 12 and driven wheel 14 are spoked wheels and therefore include spokes 21. The spokes 21 of the driven wheel 14 include drive-side spokes 21A being those spokes provided in the drive-motor transmission side of the driven wheel 14. The illustrated wheels 12 and 14 have a thirty-six spoke wheel configuration. In comparison, the wheel shown in FIG. 7 has a thirty-two spoke wheel configuration.

The illustrated bicycle 10 includes two actuation arrangements for driving the motion of the driven wheel 14:

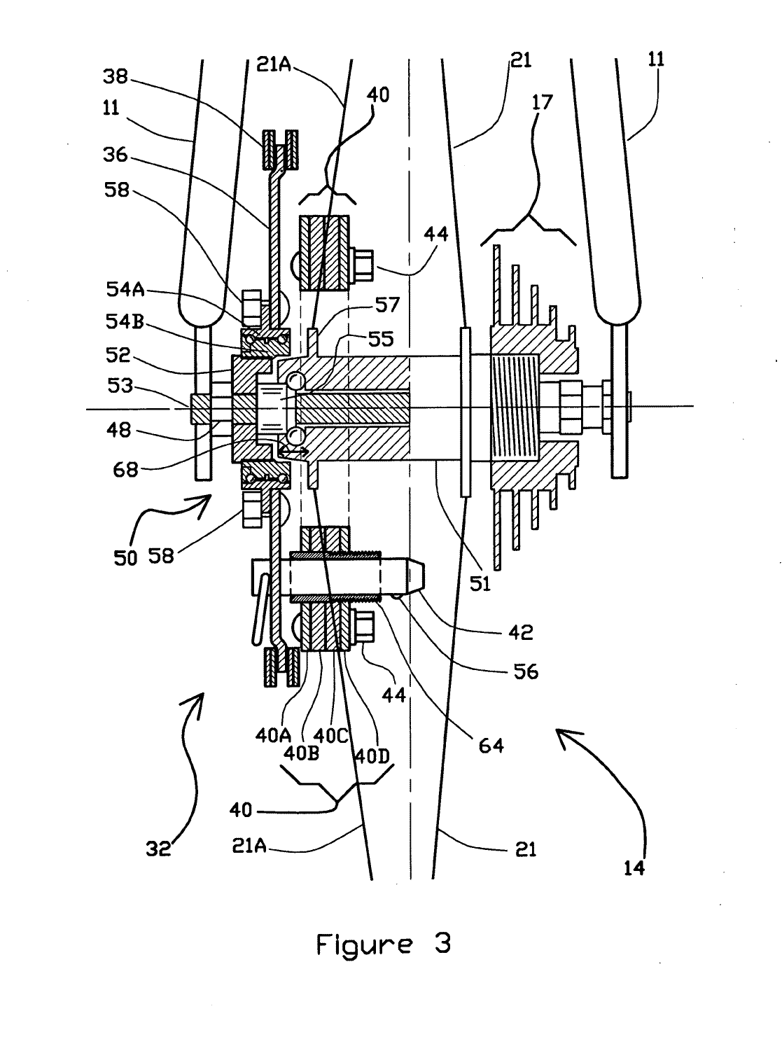

The bicycle 10 includes a conventional pedal drive arrangement 20 which includes two foot actuated crank arms 22 each having a pedal 24 which drives the rotation of a set of sprockets 26. At least one sprocket of the set of sprockets 26 is connected by a chain 28 to a gear arrangement (not shown in FIG. 1) which includes a sprocket on a multi-speed freewheel 17 (FIG. 3) which is fixedly connected to the driven wheel 14 of the bicycle 10. As can be appreciated, the bicycle 10 may include one or more derailleur devices 23 to move the chain 28 between the various sprockets of the pedal drive arrangement 20. The pedal drive arrangement 20 allows a rider to actuate the pedal sprocket 26 using the pedals 24 and manually drive the rotation of the driven wheel 14.

The bicycle 10 also includes a retrofitted drive motor 30. The drive motor 30 is connected to the driven wheel 14 through a transmission system 32 according to the present invention. In the illustrated embodiment, the drive motor 30 is an internal combustion engine having a gasoline tank 31 and an exhaust 33.

Still referring to FIG. 1, it can be seen that the transmission system 32 broadly includes a drive sprocket 34 connected to a rotating axle 35 of the drive motor 30, and a driven sprocket 36 which can be selectively connected to the driven wheel 14. The drive sprocket 34 is operatively connected to the driven sprocket 36 through the drive chain 38. It can be appreciated that each of the drive sprocket 34 and driven sprocket 36 include teeth configured to cooperate with the drive chain 38. Accordingly, the drive motor 30 can also drive rotation of the driven wheel 14 of the bicycle 10.

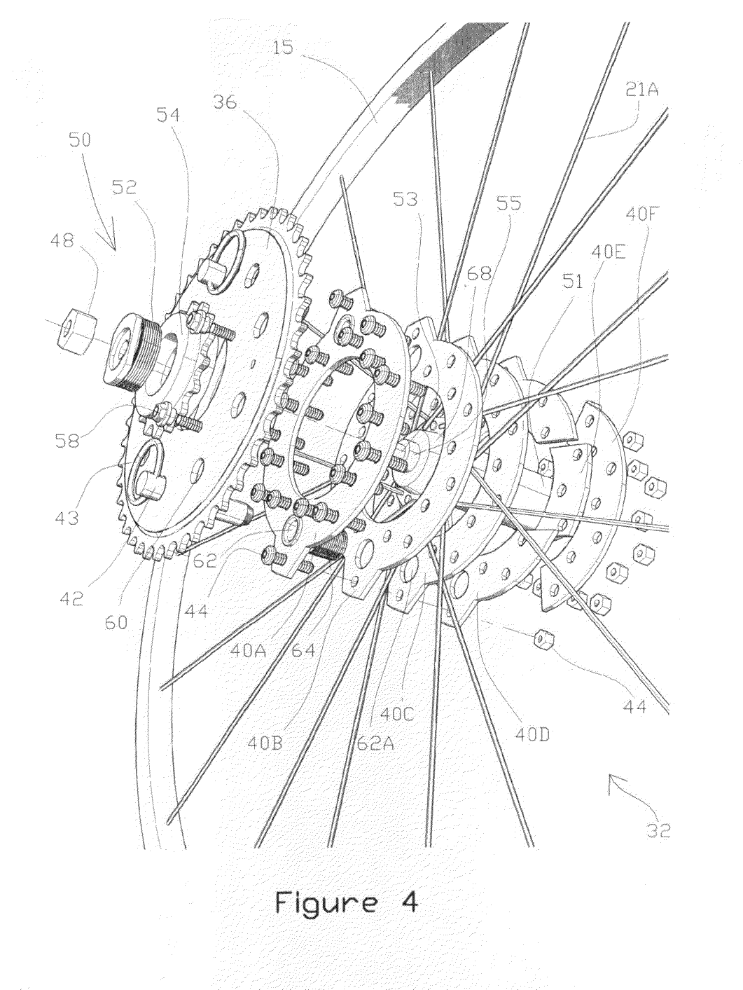

Referring now to FIGS. 2 to 4, there is shown a more detailed view of the driven sprocket 36. As is best shown in FIGS. 3 and 4, the driven sprocket 36 is not fixed to the driven wheel 14 of the bicycle 10, but rather is releasably connected to a spoke fixture assembly 40 through two coupling pins 42. The spoke fixture assembly 40 is fixedly connected to the drive-side spokes 21A of the driven wheel 14 and therefore provides a fixture onto which the driven sprocket 36 can be releasably connected.

As shown in FIGS. 3 and 4, the spoke fixture assembly 40 is formed from an assembly of interconnected annular plates 40A to 40F. In this respect, the spoke fixture assembly 40 includes an outer rigid plate 40A and an inner rigid plate 40D which form the rigid outer case/housing of the assembly 40. As can be appreciated, the outer rigid plate 40A and an inner rigid plate 40D can be constructed from one or more metals, carbon fibre, fibre reinforced glass or the like. The spoke fixture assembly 40 also includes two internal cushioning plates 40B and 40C (comprising 6 mm industrial rubber pads, although it should be understood other suitable materials could also be used) which are sandwiched between the outer rigid plate 40A and an inner rigid plate 40D and abut the drive-side spokes 21A of the driven wheel 14. As shown in FIG. 4, the inner plate 40D includes a gap in its structure to allow the inner plate 40D to be inserted around the wheel hub 51 of the driven wheel 14 without dismantling the spoked structure of the driven wheel 14. The filler plate 40E is used to fill the gap once the inner plate 40D is in position, while the bridging plate 40F re-establishes the structural integrity of the inner plate 40D.

In order to fixedly attach the spoke fixture assembly 40 to the driven wheel 14, each plate 40A to 40F is annularly aligned and interconnected using a number of connection bolts 44 to form the spoke fixture assembly 40. As shown in FIG. 3, two plates 40D and 40C are placed on an inner side of the drive-side spokes 21A of the driven wheel 14 and two plates 40B and 40A are placed on an outer side of the drive-side spokes 21A. The cushioning plates 40B and 40C abut the drive-side spokes 21A of the driven wheel 14, and conform and compress to the shape of the drive-side spokes 21A once the spoke fixture assembly 40 is clamped together. In this regard, the assembly of plates 40A to 40F are interconnected using connection bolts 44. The spoke fixture assembly 40 is fastened tightly together so that the interconnected structure forms a rigid fixture on the drive-side spokes 21A (FIG. 3). This ensures that torque from the drive sprocket 36 is evenly distributed around all of the drive-side spokes 21A of the driven wheel 14 when the spoke fixture assembly 40 is coupled to the driven sprocket 36.

As is best seen in FIG. 3, the driven sprocket 36 and spoke fixture assembly 40 are coaxially arranged about the axle 53 and wheel hub 51 of the driven wheel 14. The driven sprocket 36 and spoke fixture assembly 40 are also arranged proximate to each other to facilitate easy releasable coupling using the coupling pins 42.

The illustrated coupling pins 42 are self locking pins comprising a shaft of metal such as iron or steel, preferably a hardened metal, having a handling ring 43 at one end and a locking ball 56 at the other end. One suitable coupling pin 42 is a self-locking detent pin available from G. L. Huyett in Minneapolis, United States of America.

It should be understood that while not illustrated, the coupling pins 42 can also comprise a shaft of metal such as iron or steel, preferably a hardened metal, having a flanged head at one end and a lateral through-hole at the other end through which a locking pin can be received.

Each coupling pin 42 is used to releasably connect the driven sprocket 36 and spoke fixture assembly 40. In this respect, each of the driven sprocket 36 and spoke fixture assembly 40 include two cooperating coupling openings 60 and 62 configured to releasably receive the at least one coupling pins 42. As shown in FIGS. 2 and 4, the driven wheel 14 has a thirty-six spoked configuration which includes eighteen drive-side spokes 21A. The driven sprocket 36 is therefore configured with nine circumferentially spaced apart coupling openings 60. The spoke fixture assembly 40 includes two coupling openings 62. Each of the coupling openings 62 of the spoke fixture assembly 40 includes a threaded sleeve 64 which is inserted through the coaxial openings 62A of the bolted assembly of interconnected plates 40A to 40F forming the spoke fixture assembly 40.

As can be appreciated, two of the nine coupling openings 60 of the driven sprocket 36 can be coaxially aligned with the two coupling openings 62 of the spoke fixture assembly 40 in order to receive the coupling pins 42 and thereby interconnect the driven sprocket 36 and spoke fixture assembly 40.

In the illustrated embodiment, each of the coupling pins 42 is fitted within the coupling openings 60 and 62 of the driven sprocket 36 and locked into place at one side by the handling ring 43 and at the other side using the locking ball 56. As can be understood, the locking ball 56 is recessed within the shaft of the coupling pin 42 when the coupling pin 42 is inserted into the coupling openings 60 and 62 and returns to an extended position (as shown in FIG. 3) where it extends radially outwardly from the shaft of the coupling pin 42 once though the coupling openings 60 and 62. It should however be understood that other locking arrangements such as threaded connections or the like could equally be used.

The driven sprocket 36 is configured to move independently to the driven wheel 14 of the bicycle 10 when not connected to the driven wheel 14 through the spoke fixture assembly 40. In this respect, the driven sprocket 36 is mounted onto the axle 53 of the driven wheel 14. As shown in FIGS. 3 and 4, the driven sprocket 36 is fastened to a rotary hub 50, consisting of an axle boss 52, and a mechanical bearing 54 with an outer bearing body 54A and an inner bearing body 54B. The inner bearing body 54B is fastened onto the outer circumferential surface of the axle boss 52.

The rotary hub 50 resides on the axle 53 between a locking nut 48 and a wheel-bearing cone 55. In a common rear wheel hub, the axle boss 52 replaces a spacer between the locking nut 48 and a wheel-bearing cone 55. The locking nut 48 is tightened against the wheel-bearing cone 55 with the axle boss 52 situated between the two components. During the tightening process, the wheel-bearing cone 55 is held in place by restraining rotation of the axle boss 52 with a spanner. The wheel-bearing cone 55 would otherwise turn with the locking nut 48 and over-tighten the wheel-bearing.

In the illustrated embodiment, the rotary hub 50 comprises an axle boss 52 and a mechanical bearing 54 in the form of a modified single speed bicycle freewheel. As shown, this type of mechanical bearing 54 includes a circumferential race of teeth which is used to fasten the drive sprocket 36 to the mechanical bearing 54 using connection bolts 58. Any form of suitable single speed freewheel could be used for the mechanical bearing 54. Suitable right-hand thread single speed freewheels include the 16T Dicta Brand by Lida Machinery Co. It should be appreciated, that if a right-hand threaded single speed freewheel is used, pawls within the single speed freewheel must be removed to allow the single speed freewheel to spin freely in both directions of rotation.

The transmission system 32 according to the present invention allows a rider to selectively engage and disengage the drive motor 30 from driving rotation of the driven wheel 14 of the bicycle 10. The drive motor 30 can be used to drive rotation of the driven wheel 14 of the bicycle 10 when the coupling pins 42 are received in the coupling openings 60 and 62 to connect the driven sprocket 36 and spoke fixture assembly 40. This provides the rider of the bicycle 10 with additional power to assist the rider with pedaling. When the coupling pins 42 are removed from the coupling openings 60 and 62, the driven sprocket 36 is disconnected from the spoke fixture assembly 40 and is able to spin freely about the rotary hub 50. Similarly, the driven wheel 14 is disconnected from the transmission system between the driven wheel 14 and drive motor 30. Accordingly, the rider of the bicycle 10 is able to use the pedal drive arrangement 20 to drive rotation of the driven wheel 14 of the bicycle 10 without having to also actuate the associated transmission system 32.

It should be appreciated that the axle 53 and associated wheel hub 51 can have several different configurations depending on the manufacturer of the bicycle 10 or driven wheel 14. In this respect, a driven wheel 14 can have different configurations of wheel hubs 51. In some embodiments, the wheel hub 51 can have a narrow hub extension 68 such as the driven wheel 14 illustrated in FIG. 3. The hub extension 68 is that portion of the wheel hub 51 beyond the hub flange 57 on which the drive-side spokes 21A are attached to the wheel hub 51. In the illustrated embodiment, the wheel hub 51 has a narrow hub extension 68 which provides very little space on which to mount the rotary hub 50. Accordingly the axle boss 52 between locking nut 48 and wheel bearing cone 55 is needed to mount the mechanical bearing 54 in the form of a single speed bicycle freewheel such that it protrudes over the hub extension 68. In other embodiments, the hub extension 68 is wider, allowing the mechanical bearing 54 to be mounted directly on the hub extension 68.

Different bicycles 10 can have differing spoke 21 configurations. In this respect, wheel configuration variables include:

1. The number of spokes 21 in a wheel (S);

2. The circle diameter of the spoke holes on the side of the hub opposite to the pedal chain sprocket of the hub flange 57 of the wheel (HCD); and

3. The effective rim diameter of the inside of the wheel rim 15 (ERD).

Accordingly, a convention has been established whereby the spoke configuration for a wheel with 36 spokes (S) with a 45 millimetre hole circle diameter (HCD) and 610 millimetre effective rim diameter (ERD) is designated 36Sx45HCDx610ERD.

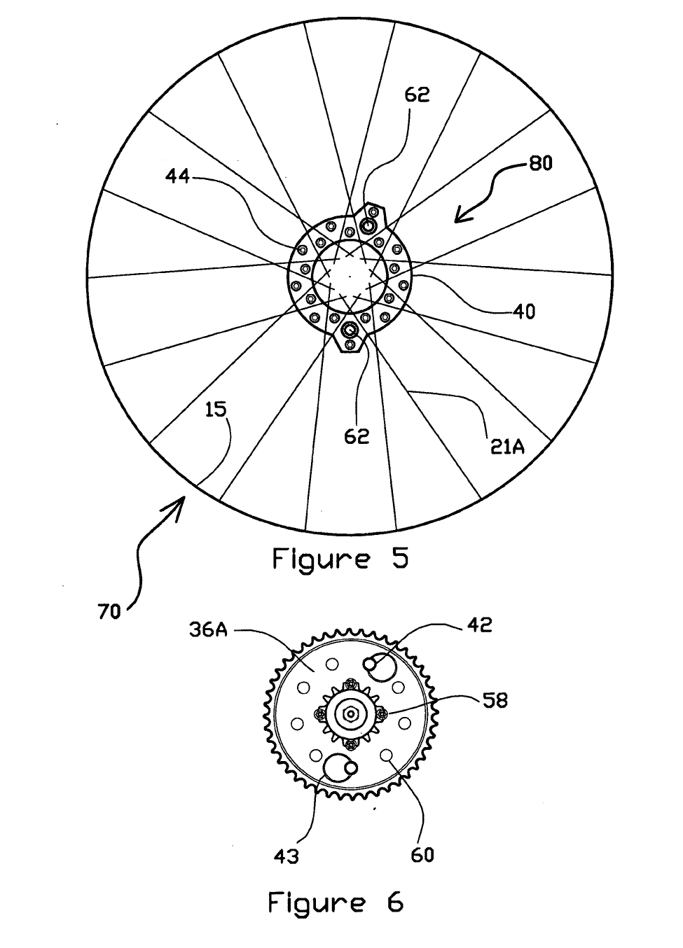

Most common bicycle wheels have a standard lacing of thirty-six or thirty-two spokes where each spoke crosses three other spokes. The two most common spoke lacing configurations are shown in FIGS. 5 and 7. FIG. 5 shows spoke lacing configuration 36Sx45HCDx560ERD. This is a common mountain bike wheel spoke lacing configuration. FIG. 7 shows spoke lacing configuration 32Sx45HCDx610ERD. This is less common, but could be found on a flat bar road bike wheel.

Of course, the configuration of the driven wheel 36 and spoke fixture assembly 40 is preferably tailored to these different spoke configurations and hub extension 68 configurations. FIGS. 5 to 10 show three different wheel configurations 70, 71 and 72 and corresponding spoke fixture assemblies 80, 81 and 82 and driven sprocket 36A, 36B and 36C configurations. In this respect:

FIG. 5 shows the drive-side spokes 21A and the spoke fixture assembly 80 for a driven wheel 14 with a 36Sx45HCDx560ERD wheel configuration 70, a less common alternative to 36 spoke wheels on a common adult mountain bike bicycle.

FIG. 6 shows the driven sprocket 36A matching the wheel configuration shown in FIG. 5.

FIG. 7 shows the drive-side spokes 21A and the spoke fixture assembly 81 for a driven wheel 14 with a 32Sx45HCDx610ERD wheel configuration 71, likely to be found on a flat-bar road bike bicycle.

FIG. 8 shows the driven sprocket 36B matching the wheel configuration shown in FIG. 7.

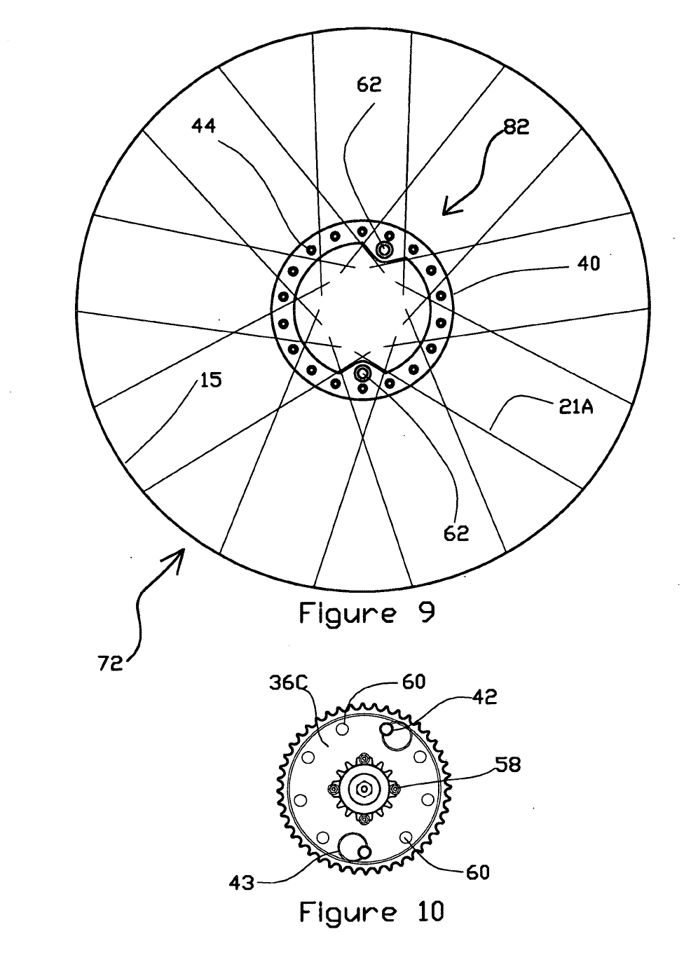

FIG. 9 shows the drive-side spokes 21A and the spoke fixture assembly 82 for a driven wheel 14 with a 36Sx93HCDx610ERD wheel configuration 72, likely to be found on a wide diameter hub, such as an internally geared hub, or a hub containing an electric motor.

FIG. 10 shows the driven sprocket 36C matching the wheel configuration shown in FIG. 5.

As can be appreciated, the spoke configuration 71 shown in FIG. 7 has a different configuration to the spoke configuration 70 of bicycle 10 shown in FIG. 5. Accordingly, the coupling openings 62 are located in a different position in order accommodate the location of the spokes 21A in this spoke configuration 71.

It should be appreciated, that in those embodiments where the driven wheel 14 has a wide hub extension 68, a left-hand single speed bicycle freewheel could be used for the mechanical bearing 54. Suitable left-hand thread single speed bicycle freewheels include American Cycle Systems (ACS) BMX Southpaw 16T freewheels. It should be appreciated that if a left-hand threaded freewheel is used, such as a BMX Southpaw freewheel, the driven sprocket 36 is generally constantly engageable with the driven wheel 14 in the direction of actuation due to the unidirectional rotation provided by this type of freewheel. Accordingly, the coupling pins 42 need only be used to couple the drive sprocket 36 and spoke fixture assembly 40 together when starting the drive motor 30.

Those skilled in the art will appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1-17. (canceled)

18. A transmission system for a cycle having a drive means and at least one driven wheel, the transmission system comprising:
a driven member operatively connected to said drive means, said driven member being selectively driven by said drive means;
at least one fixture fixedly connected to said driven wheel; and
at least one coupling member which is releasably receivable in or on each of said driven member and said fixture to releasably connect said driven member to said fixture and thereby allow the drive means to drive rotation of said driven wheel.

19. The transmission system for a cycle according to claim 18, wherein said cycle further comprising a pedal drive arrangement for manually driving said driven wheel of said cycle, and wherein said pedal drive arrangement can be used to drive rotation of said driven wheel when said coupling member is removed to disconnect said driven member and said fixture.

20. The transmission system for a cycle according to claim 18, wherein said driven member is selected from the group consisting of a sprocket, and a pulley wheel.

21. The transmission system for a cycle according to claim 20, wherein said driven member and said fixture are coaxially arranged about an axis of rotation of said driven wheel.

22. The transmission system for a cycle according to claim 21, wherein each of said driven member and said fixture further comprising one or more cooperating openings configured to releasably receive said coupling member.

23. The transmission system for a cycle according to claim 22, wherein said cooperating openings of each of said driven member and said fixture being coaxially aligned to receive said coupling member.

24. The transmission system for a cycle according to claim 23, wherein said coupling member further comprising one or more shafts configured to be received in said one or more cooperating openings of said driven member and said fixture.

25. The transmission system for a cycle according to claim 24, wherein each of said one or more shafts are fitted within said one or more cooperating openings of said driven member and said fixture, each said shaft further comprising a locking element to lock said one or more shafts within said cooperating openings.

26. The transmission system for a cycle according to claim 25, wherein said locking element further comprising an element selected from the group consisting of a removable pin, nut, and radially biased locking member.

27. The transmission system for a cycle according to claim 26, wherein said driven wheel further comprising three or more spokes, and said fixture fixedly mounts to at least three of said spokes.

28. The transmission system for a cycle according to claim 27, wherein said driven member is mounted on a rotatable member that rotates independently relative to said driven wheel.

29. The transmission system for a cycle according to claim 28, wherein said rotatable member further comprising a rotary hub coaxially aligned with the axis of rotation of said driven wheel, said rotary hub further comprising a bearing section allowing at least one section of said rotary hub to rotate independently relative to said driven wheel.

30. The transmission system for a cycle according to claim 29, wherein said driven member is operatively connected to said drive means using a chain selected from the group consisting of a roller chain, and a belt.

31. The transmission system for a cycle according to claim 30, wherein said drive means is a motorized drive means selected from the group consisting of an electric motor, an internal combustion engine, and a pneumatic motor.

32. The transmission system for a cycle according to claim 31, wherein the cycle is a bicycle having a front wheel and a rear wheel, said driven wheel comprising said rear wheel of said bicycle.

33. A transmission system for a cycle having a drive means and at least one driven wheel, the transmission system comprising:
a driven member operatively connected to said drive means, said driven member being selectively driven by said drive means;
at least one fixture fixedly connected to said driven wheel; and
at least one coupling member which is releasably receivable in or on each of said driven member and said fixture to releasably connect said driven member to said fixture and thereby allow the drive means to drive rotation of said driven wheel;
wherein said driven member and said fixture are coaxially arranged about an axis of rotation of said driven wheel;
wherein each of said driven member and said fixture further comprising one or more cooperating openings configured to releasably receive said coupling member, said cooperating openings of each of said driven member and said fixture being coaxially aligned to receive said coupling member.

34. The transmission system for a cycle according to claim 33, wherein said coupling member further comprising one or more shafts configured to be received in said one or more cooperating openings of said driven member and said fixture, each of said one or more shafts being fitted within said one or more cooperating openings of said driven member and said fixture, each said shaft further comprising a locking element to lock said one or more shafts within said cooperating openings.

35. The transmission system for a cycle according to claim 34, wherein said driven member is mounted on a rotatable member that rotates independently relative to said driven wheel, said rotatable member further comprising a rotary hub coaxially aligned with the axis of rotation of said driven wheel, said rotary hub further comprising a bearing section allowing at least one section of said rotary hub to rotate independently relative to said driven wheel.

36. A transmission system for a cycle having a drive means and at least one driven wheel, the transmission system comprising:
a driven member operatively connected to said drive means, said driven member being coaxially arranged with an axis of rotation of said driven wheel and being selectively driven by said drive means;
at least one fixture fixedly connected to said driven wheel; and
two or more coupling shafts which are releasably receivable within cooperating openings in said driven member and said fixture to releasably connect said driven member to said fixture and thereby allow said drive means to drive rotation of said driven wheel.

37. The transmission system for a cycle according to claim 36, wherein the cycle is a bicycle having a front wheel and a rear wheel, said driven wheel comprising said rear wheel of said bicycle.
